(19) United States
(12) Patent Application Publication
(10) Pub. No.: US 2016/0361735 A1
(43) Pub. Date: Dec. 15, 2016

(54) ERGONOMIC PAINT ROLLER FRAME

(71) Applicant: ZIBRA, LLC, MOORESVILLE, NC (US)

(72) Inventor: Christopher ROCKWELL, BELLEVUE, WA (US)

(21) Appl. No.: 14/734,427

(22) Filed: Jun. 9, 2015

(51) Int. Cl. B05C 17/02; B25G 1/10; B25G 3/00

(52) U.S. Cl. CPC B05C 17/0205; B05C 17/0245; B25G 3/00; B25G 1/102

(57) ABSTRACT

An ergonomic paint roller frame includes: (a) a cage configured to receive a roller; (b) a shank, to which the cage is attached and configured to rotate relative thereto about an axis of rotation; (c) a handle to which the shank is attached in fixed position relative thereto, the handle comprising therealong in sequence from a first, proximal end thereof to a second, distal end thereof, (i) a first, generally elongate handle portion, (ii) a first, curved elbow handle portion, (iii) a second, generally elongate handle portion, (iv) a second, curved elbow handle portion, and (v) a third, generally elongate handle portion; and (d) wherein the handle portions of the handle generally extend relative to each other so as to be bisected by a handle plane, relative to which handle plane the axis of rotation is generally orthogonally oriented.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to a paint rollers used in painting and, more specifically, to an ergonomic paint roller frame for a paint roller.

There are a variety of paint rollers including paint roller frame assemblies. Prior art paint roller are disclosed, for example, in U.S. Pat. Nos. 3,060,555; 3,088,152; 3,623,180; 6,687,945; 6,968,599; Des. 279,254; Des. 345,058; Des. 367,963; Des. 417,381; D466,699; D475,203; and D475,535. Additional exemplary prior art paint rollers are disclosed in U.S. Application Publication Nos. 2006/0130261; 2006/0130262; and 2011/0131745. It is believed that even in view of the innovations that have been made in paint rollers, as seen in the aforementioned U.S. patent properties, a need exists for improvement in paint rollers. At least one aspect or feature of the present invention is believed to represent such improvement.

### SUMMARY OF THE INVENTION

The present invention includes many aspects and features.

In an aspect of the invention, a paint roller frame includes: (a) a cage configured to receive a roller; (b) a shank, to which the cage is attached and configured to rotate relative thereto about an axis of rotation; (c) a handle to which the shank is attached in fixed position relative thereto, the handle comprising therealong in sequence from a first, proximal end thereof to a second, distal end thereof, (i) a first, generally elongate handle portion, (ii) a first, curved elbow handle portion, (iii) a second, generally elongate handle portion, (iv) a second, curved elbow handle portion, and (v) a third, generally elongate handle portion; and (d) wherein the handle portions of the handle generally extend relative to each other so as to be bisected by a handle plane, relative to which handle plane the axis of rotation is generally orthogonally oriented. The handle preferably is ergonomically shaped relative to the cage.

In a feature, the third, generally elongate handle portion longitudinally extends along its length along a third handle portion axis that is generally orthogonal to and intersects the axis of rotation.

In a feature, the paint roller frame further includes an adapter attached at the distal end of the handle, the adapter attaching the shank to the handle. In this respect, the shank and the adapter preferably are bisected by a shank plane within which the axis of rotation and the third handle portion axis extend, and preferably the shank plane orthogonally intersects the handle plane. Furthermore, a proximal end of the shank preferably extends through the adapter and is received within the distal end of the handle, and the adapter frictionally fits within the distal end of the handle. The adapter preferably is secured to the distal end of the handle by threaded engagement; the adapter is secured to the distal end of the handle by an adhesive; or both.

In a feature, the paint roller frame further includes a handgrip for gripping of the paint roller frame by hand. In this respect, the handgrip preferably comprises a no-slip resilient material; a rubber material; a resilient and compressible material; a foam material; and combinations thereof, which may not be mutually exclusive. Additionally, the handgrip preferably extends from the proximal end of the elongate handle portion representing the lowest elevation of the paint roller frame as seen from the side, to proximate the first, curved elbow handle portion above the highest elevation of the cage as seen from the side.

In a feature, the paint roller frame further includes the shank is bisected by a shank plane within which the axis of rotation and the third handle portion axis extend, and the second elongate handle portion extends to the second, curved elbow portion proximate the shank plane.

In a feature, the paint roller frame further includes the first elongate handle portion is longer than the second elongate handle portion.

In a feature, the paint roller frame further includes an inner angle formed by the first curved elbow handle portion is acute and that an inner angle formed by the second curved elbow handle portion is obtuse.

In a feature, the paint roller frame further includes the handle is formed from aluminum tubing.

In a feature, the paint roller frame further includes the shank is formed from aluminum.

In a feature, the paint roller frame further includes at least one of the dimensions disclosed in FIGS. 13 and 15, including lengths and angles.

In a feature, the paint roller frame further includes the dimensions of disclosed in FIGS. 13 and 15, including lengths and angles.

In an aspect, a paint roller includes a paint roller frame as disclosed herein.

In an aspect, a method of painting includes using a paint roller frame as disclosed herein.

In an aspect, a method of manufacture comprises making a paint roller frame as disclosed herein.

In an aspect, a method of manufacture comprises making a paint roller including a paint roller frame as disclosed herein.

Other aspects of the invention comprise methods of using apparatus of the foregoing aspects.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals.

FIG. 1 is a perspective front view of a preferred paint roller frame in accordance with one or more aspects and features of the present invention.

FIG. 2 is a perspective back view of the paint roller frame of FIG. 1.

FIG. 3 is a perspective right side view of the paint roller frame of FIG. 1.

FIG. 3A is a photograph showing a perspective right side view of a preferred paint roller in accordance with one or more aspects and features of the present invention.

FIG. 4 is a perspective left side view of the paint roller frame of FIG. 1.

FIG. 5 is a perspective top view of the paint roller frame of FIG. 1.

FIG. 5A is a photograph showing a perspective top view of the paint roller of FIG. 3A.

FIG. 5B is a photograph showing a perspective top view of the paint roller of FIG. 5A, wherein the paint roller has been removed to show just the paint roller frame.

FIG. 6 is a perspective bottom view of the paint roller frame of FIG. 1.

FIG. 6A is a photograph showing a perspective bottom view of the paint roller of FIG. 5A.

FIG. 6B is a photograph showing a perspective bottom view of the paint roller frame of FIG. 5B.

FIG. 7 is a generally isometric view of the paint roller frame of FIG. 1.

FIG. 7A is a photograph showing a generally isometric view of the paint roller of FIG. 5A.

FIG. 8 is a schematic illustration of a generally isometric view of a paint roller frame in accordance with one or more aspects and features of the present invention.

FIG. 9 is a schematic illustration of a top plan view of the paint roller frame of FIG. 8.

FIG. 10 is a schematic illustration of a side elevational plan view of the paint roller frame of FIG. 8.

FIG. 11 is a schematic illustration of a front elevational plan view of the paint roller frame of FIG. 8.

FIG. 12 is a schematic illustration of a partially exploded, generally isometric shaded view of the paint roller frame of FIG. 8.

FIG. 13 is a schematic illustration of a side elevational plan view of the handle of the paint roller frame of FIG. 8, wherein various preferred dimensions are set forth.

FIG. 14 is a schematic illustration of a front elevational plan view of the adapter of the roller frame of FIG. 8 by which the handle is attached to the shank of the paint roller frame.

FIG. 15 is a schematic illustration of a cross-sectional view of the adapter taken along the line B-B of FIG. 14, wherein various preferred dimensions are set forth.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention is to be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. 112, subsection (f), no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” When used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the invention are next described. The following description of one or more preferred embodiments is merely exemplary in nature and is in no way intended to limit the invention, its implementations, or uses.

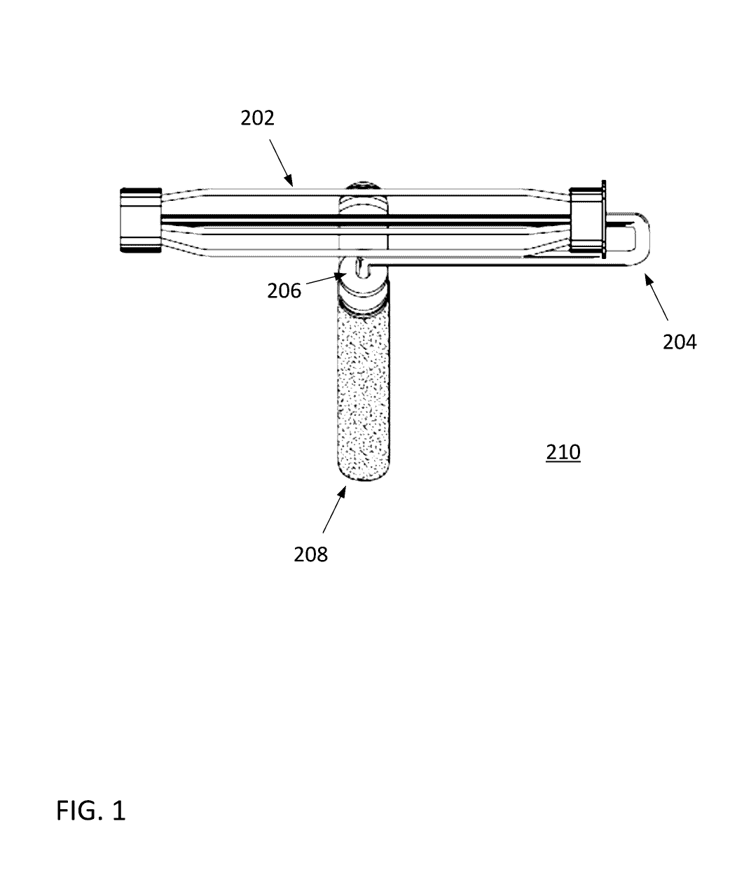

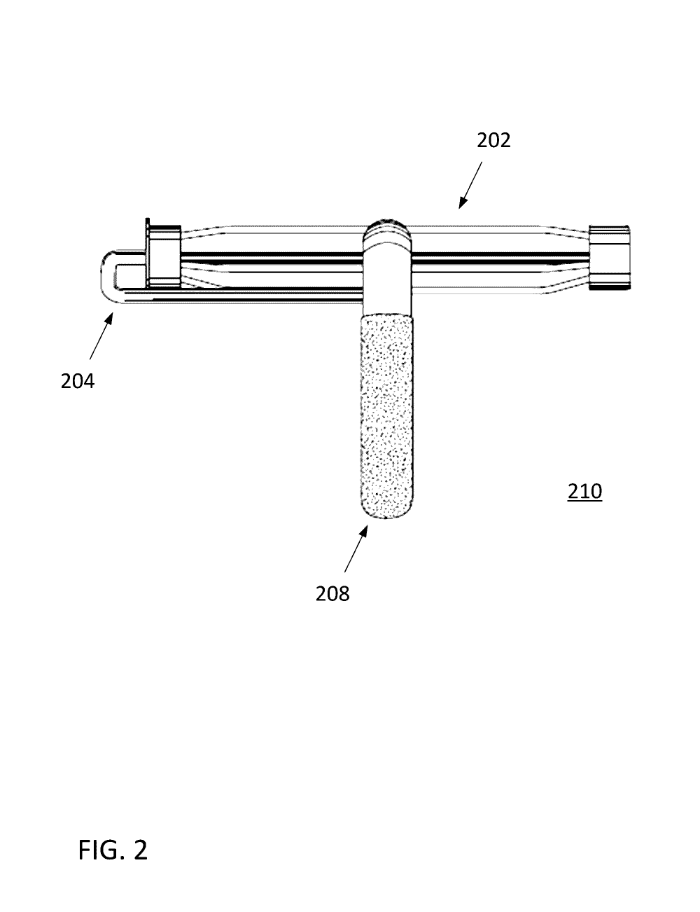

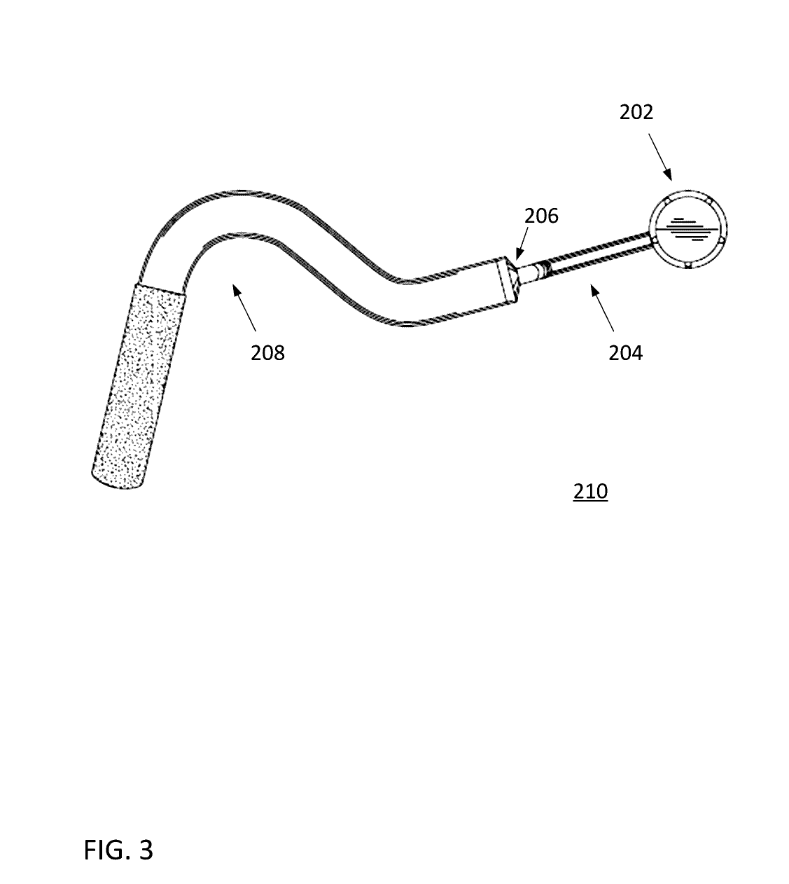

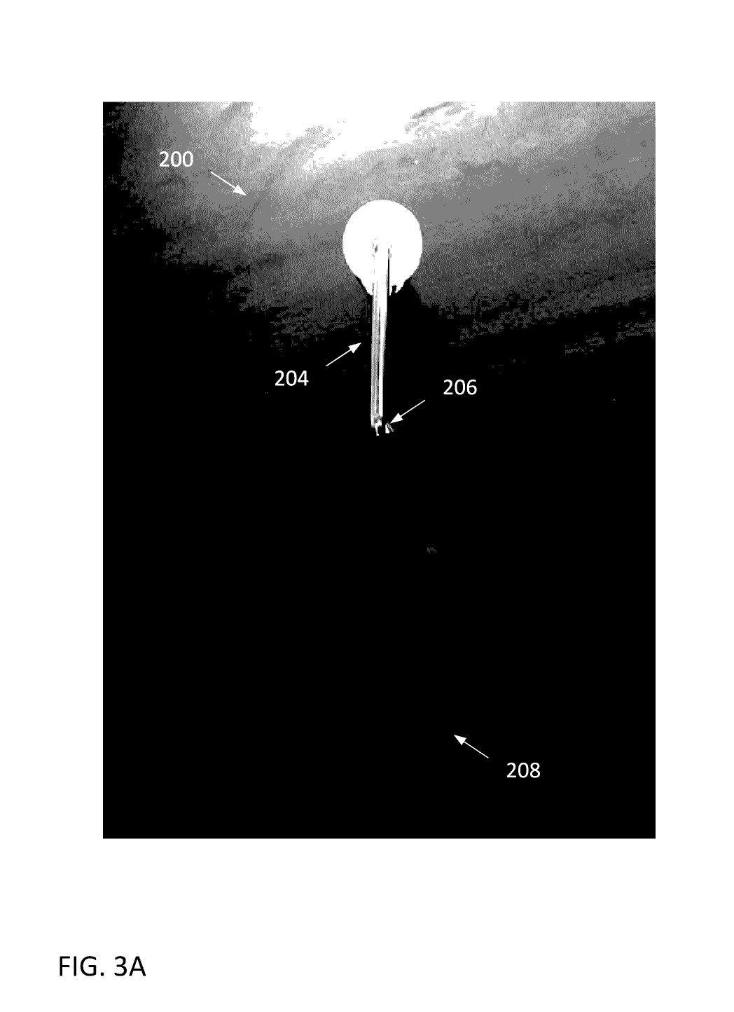

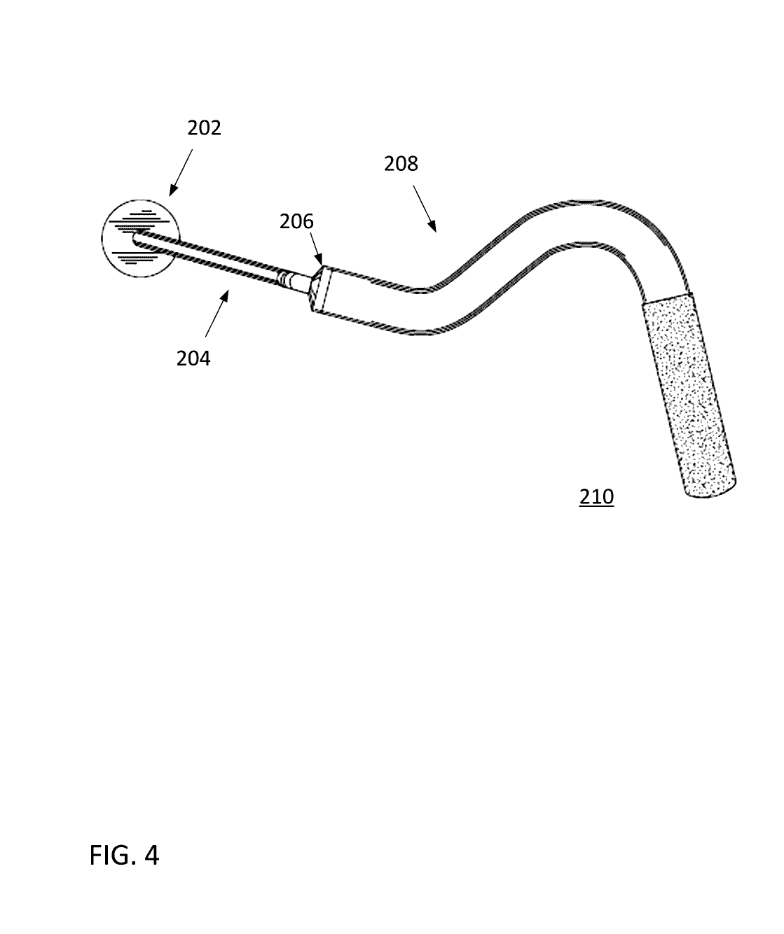

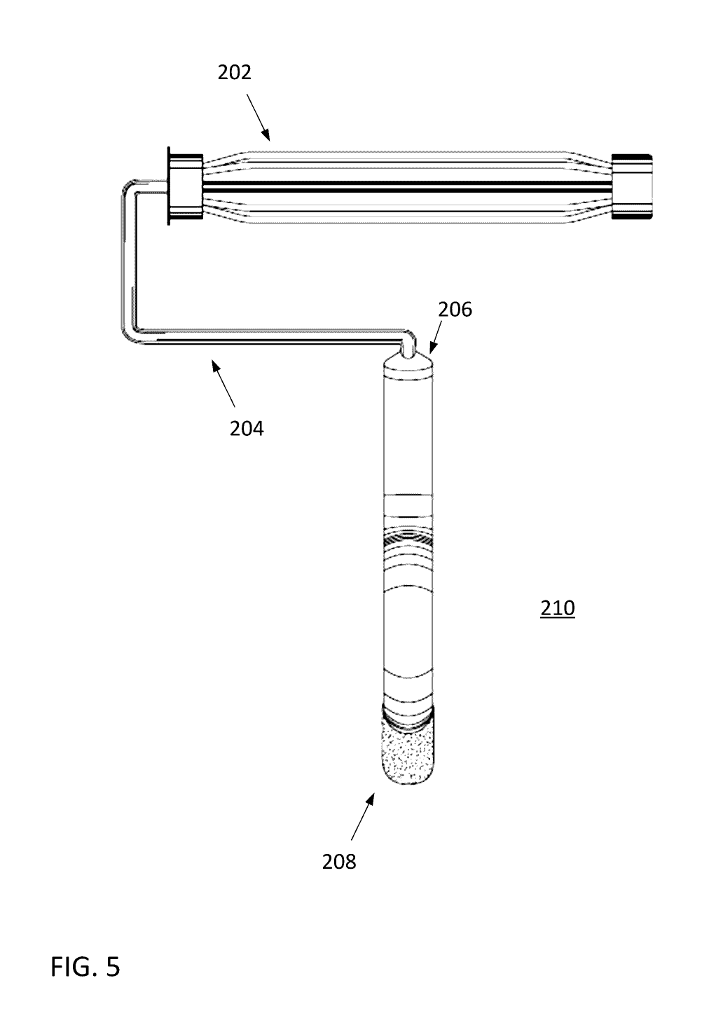

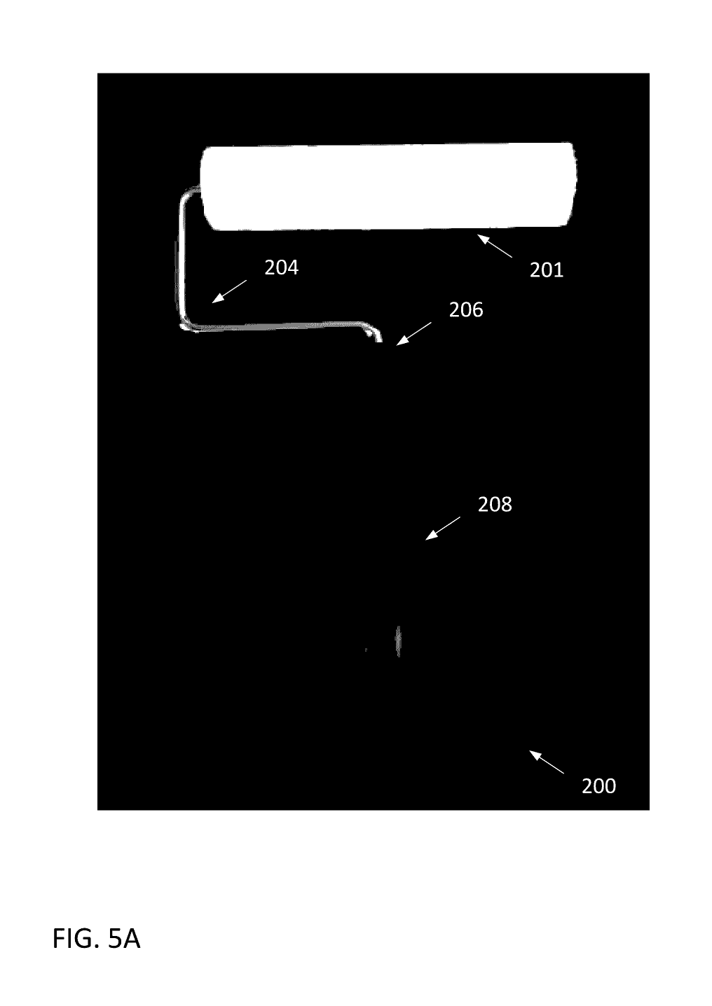

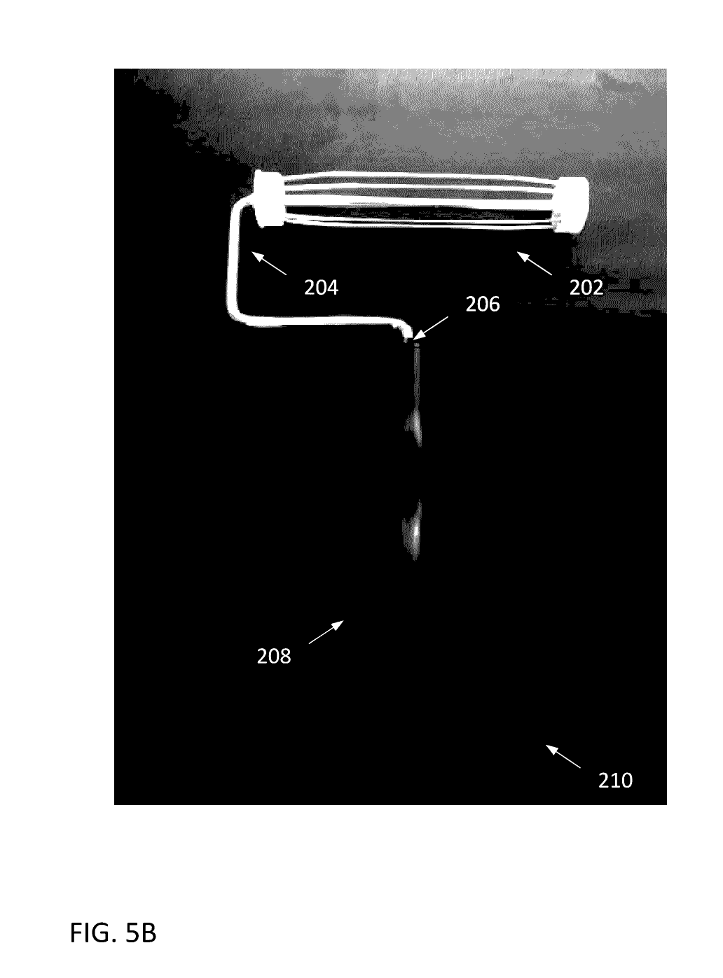

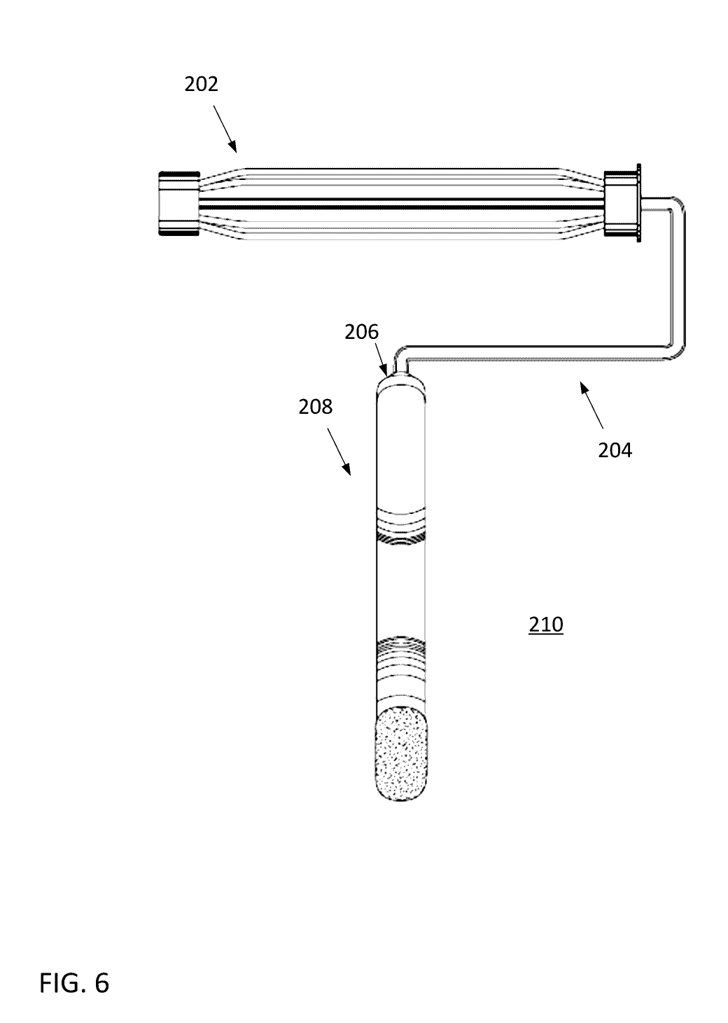

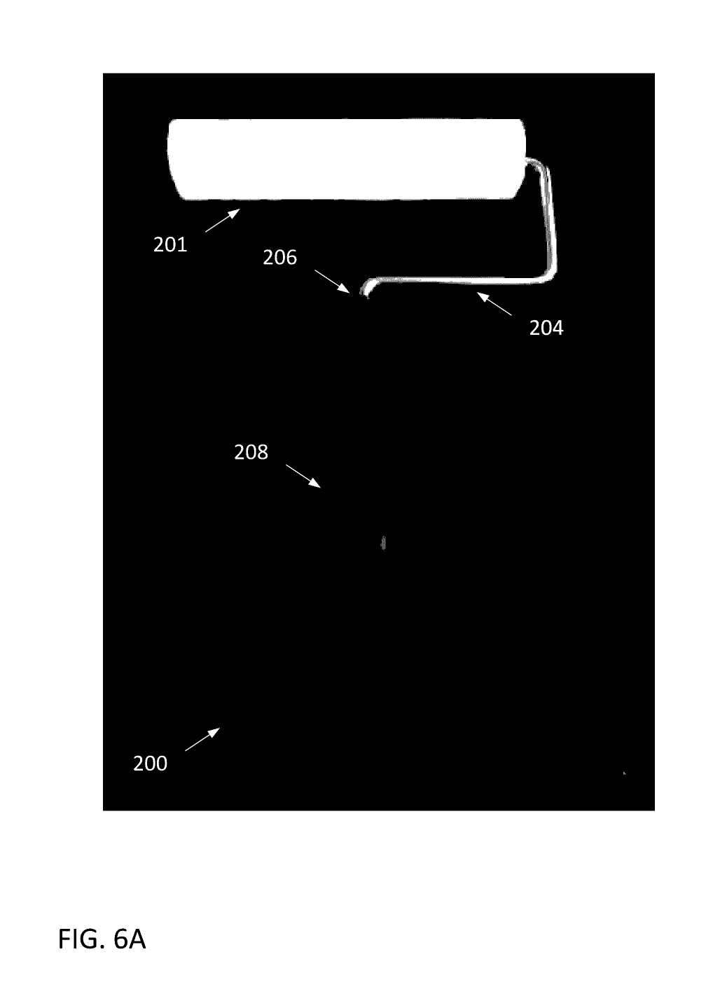

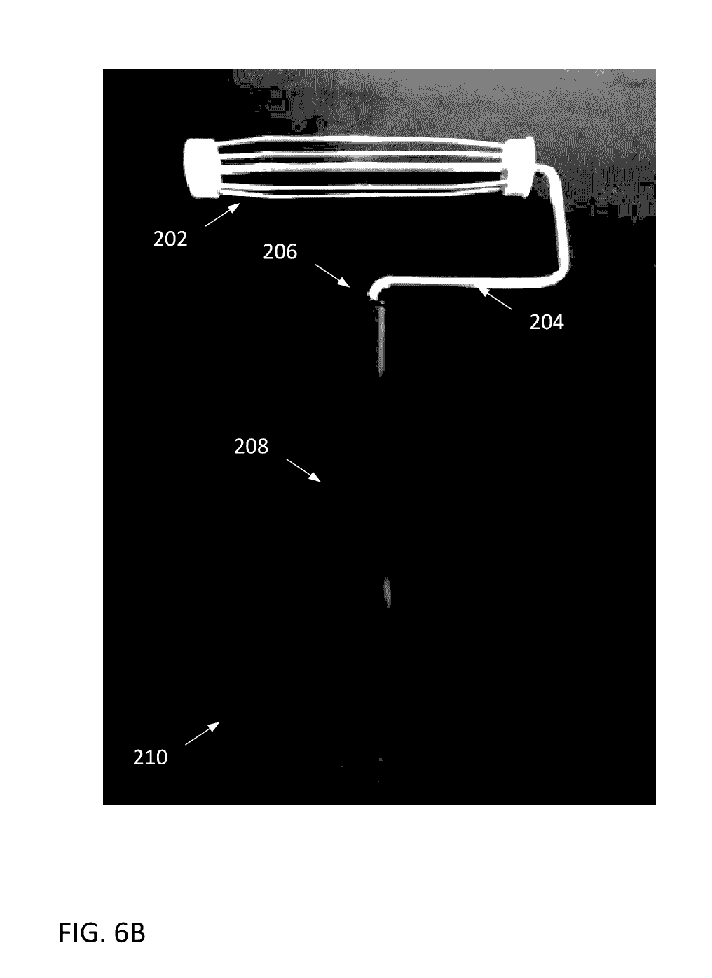

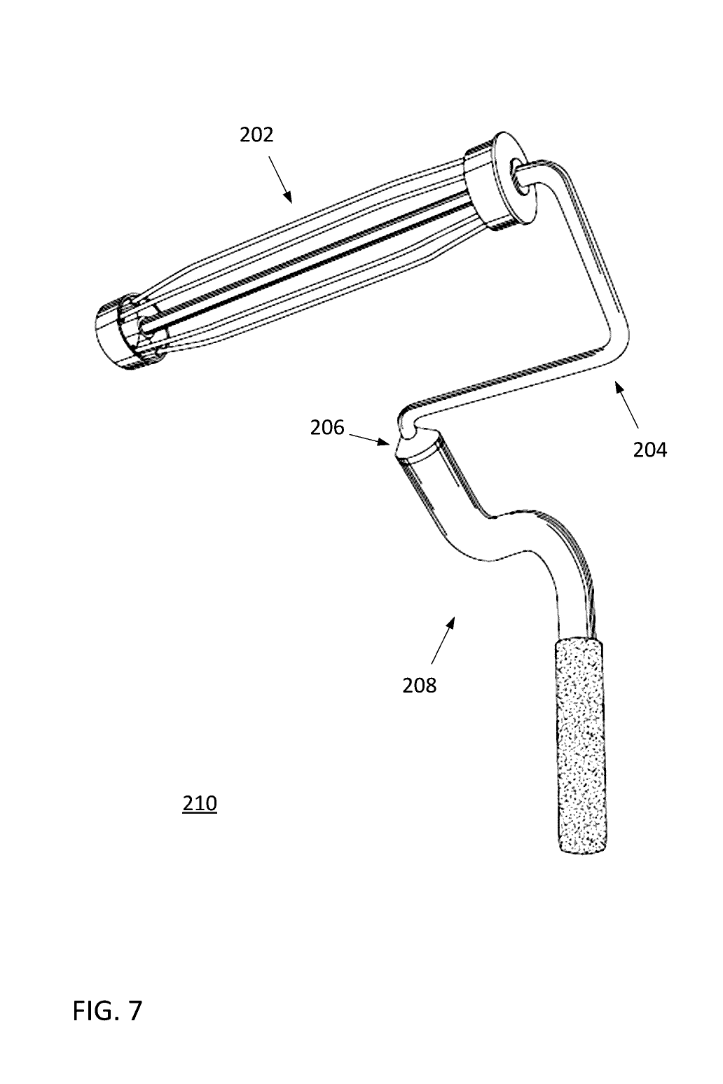

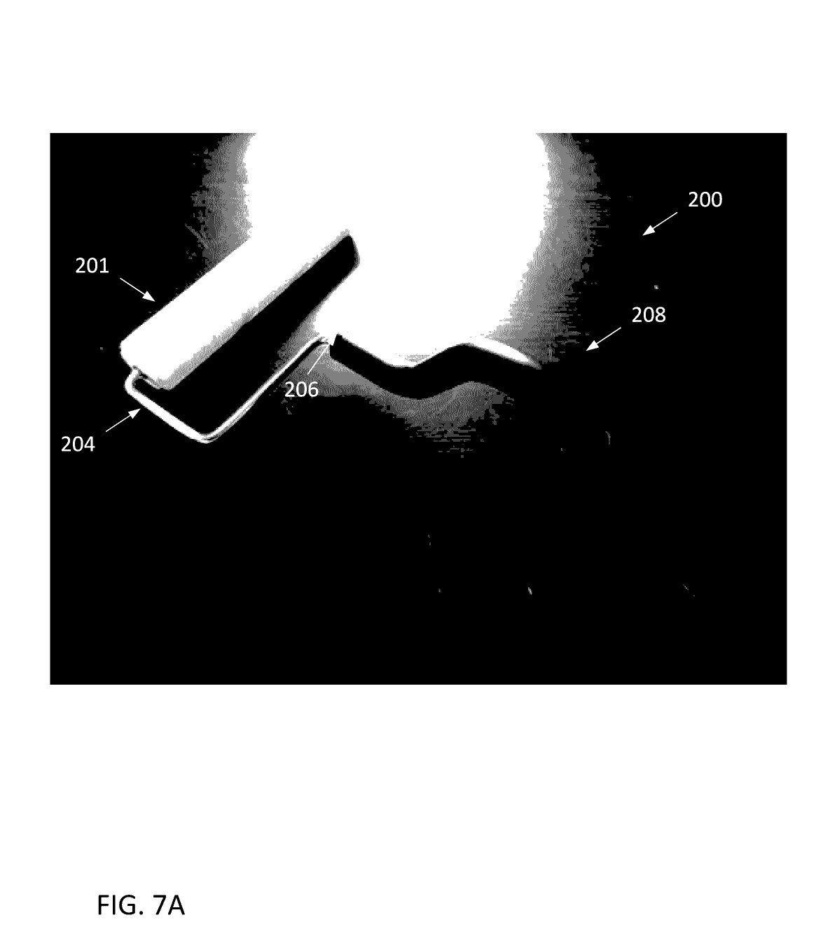

FIG. 1 is a perspective front view of a preferred paint roller frame 100 in accordance with one or more aspects and features of the present invention. Additionally, FIG. 2 is a perspective back view of the paint roller frame 100; FIG. 3 is a perspective right side view of the paint roller frame 100; FIG. 4 is a perspective left side view of the paint roller frame 100; FIG. 5 is a perspective top view of the paint roller frame 100; FIG. 6 is a perspective bottom view of the paint roller frame 100; and FIG. 7 is a generally isometric view of the paint roller frame 100.

The paint roller frame 100 comprises a cage 102 configured to receive a roller; a shank 104; an adapter 106; and a handle 108. The cage 102 is attached to the shank 104 (sometimes referred to as an arm) and is rotatable relative thereto, whereby a roller rotates when positioned on the cage 102, as is conventional. The adapter 106 attaches the shank 104 to the handle 108 in fixed position relative thereto.

FIG. 3A is a photograph showing a perspective right side view of a preferred paint roller 200 that has been made in accordance with one or more aspects an feature of the present invention. The paint roller 200 includes a paint roller frame, of which the paint roller frame 100 is representative, and a roller 201 that has been positioned onto a cage of the paint roller 200 and that is rotatable relative to the shank 204. The paint roller 200 further includes an adapter 206 and handle 208. Similarly, FIG. 5A is a photograph showing a perspective top view of the paint roller 200; FIG. 6A is a photograph showing a perspective bottom view of the paint roller 200; and FIG. 7A is a photograph showing a generally isometric view of the paint roller 200.

Additionally, FIG. 5B is a photograph showing a perspective top view of the paint roller 200, wherein the paint roller 201 itself has been removed to show the paint roller frame 210 including the cage 202. FIG. 6B is a photograph showing a perspective bottom view of the paint roller frame 210.

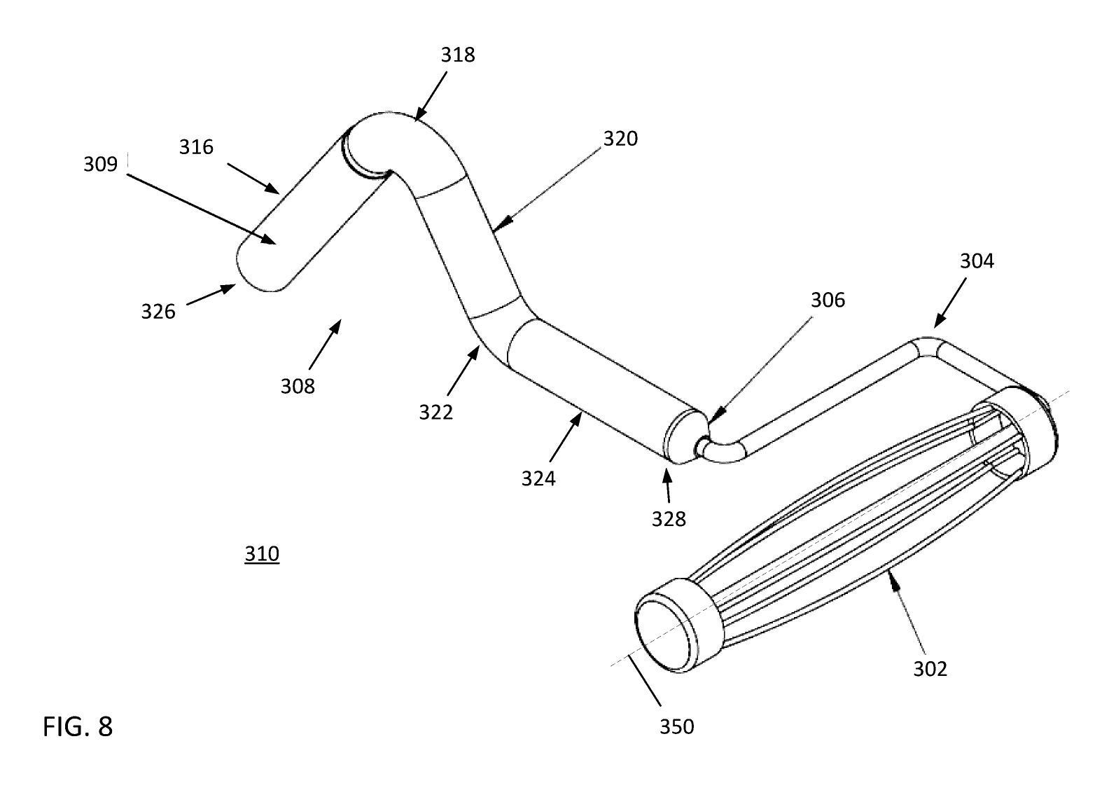

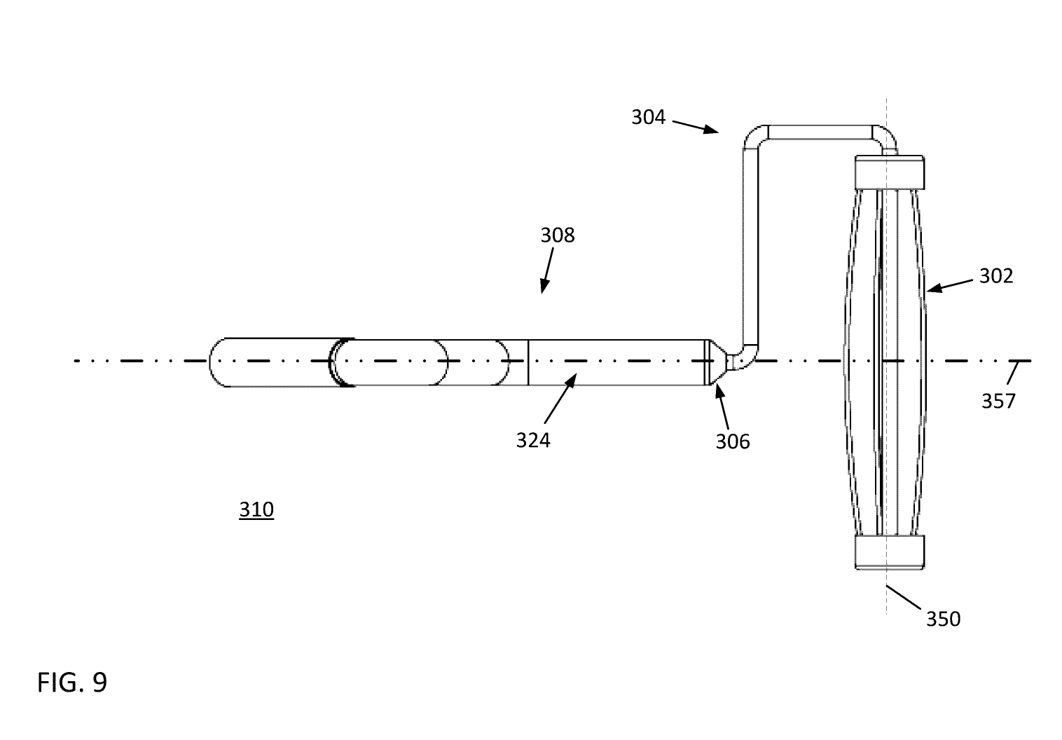

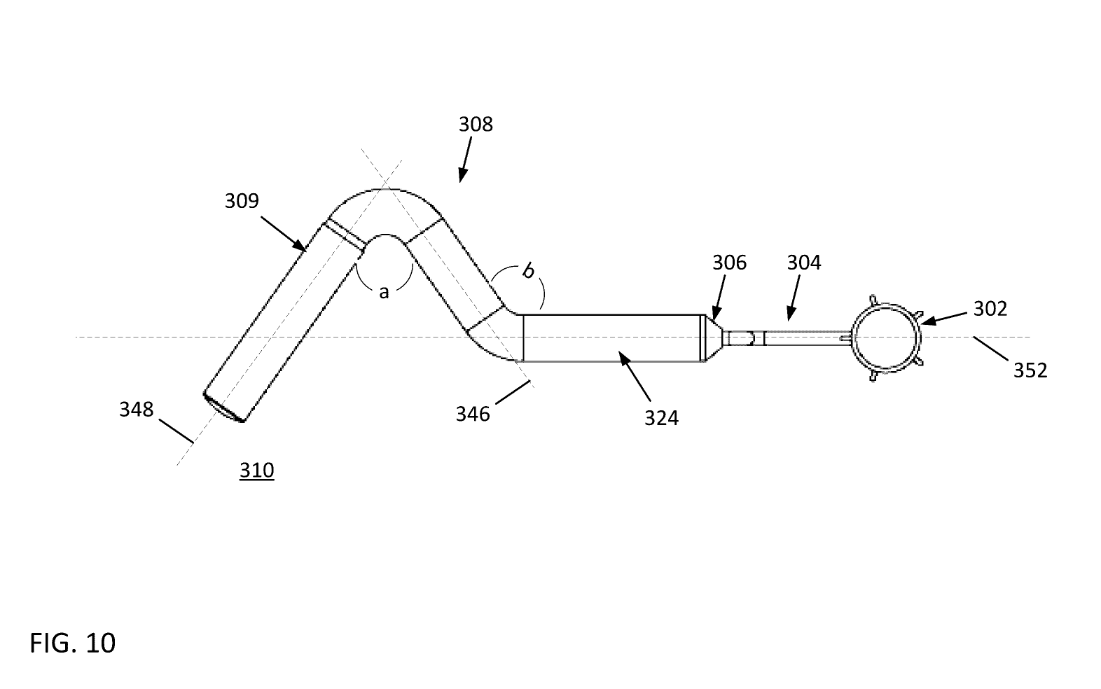

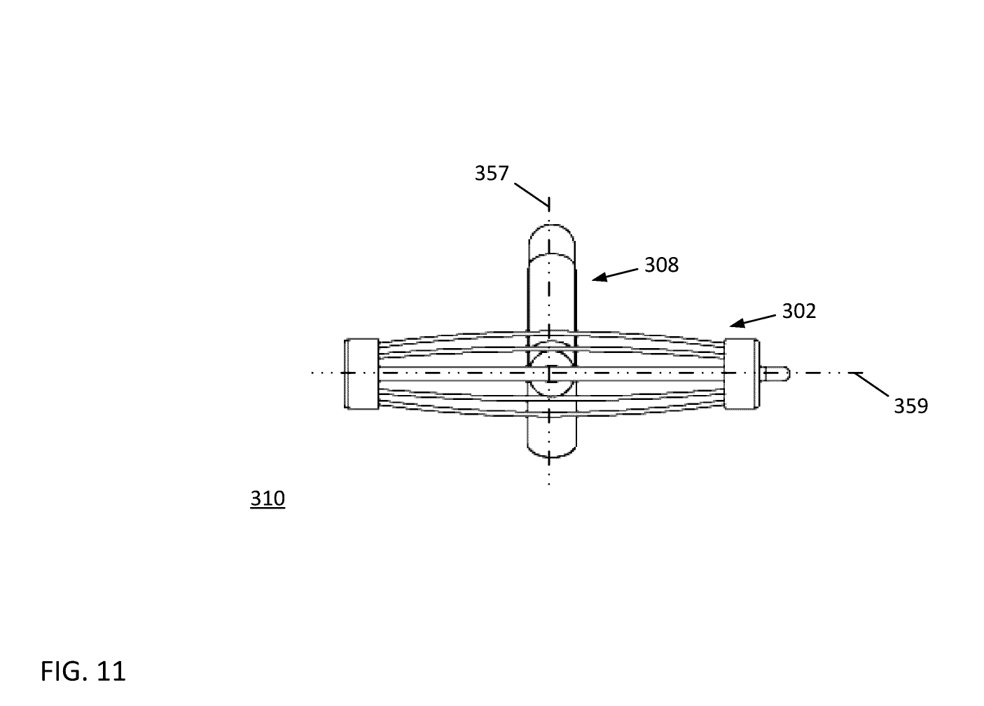

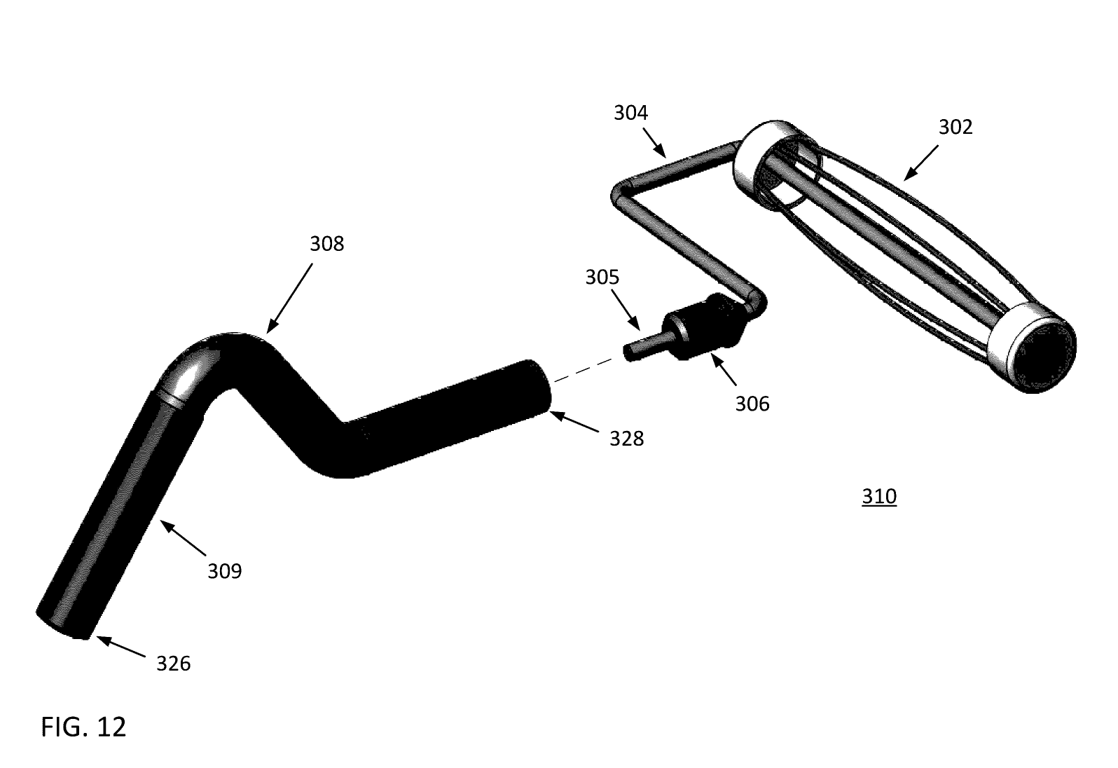

FIG. 8 is a schematic illustration of a generally isometric view of a paint roller frame 310 in accordance with one or more aspects and features of the present invention. Similarly, FIG. 9 is a schematic illustration of a top plan view of the paint roller frame 310; FIG. 10 is a schematic illustration of a side elevational plan view of the paint roller frame 310; FIG. 11 is a schematic illustration of a front elevational plan view of the paint roller frame 310; and FIG. 12 is a schematic illustration of a partially exploded, generally isometric shaded view of the paint roller frame 310.

As seen in FIGS. 8-12, the paint roller frame 310 comprises a cage 302 that is configured to receive a roller; a shank 304; an adapter 306; and a handle 308. The cage 302 is attached to the shank 304 and is rotatable relative thereto about and axis 350, whereby a roller rotates when positioned on the cage 302, as is conventional. The adapter 306 attaches the shank 304 to the handle 308 in fixed position relative thereto.

The handle 308 includes therealong in sequence from a first, proximal end 326 thereof to a second, distal end 328 thereof: a first, generally elongate portion 316; a first, curved elbow portion 318; a second, generally elongate portion 320; a second, curved elbow portion 322; and a third, generally elongate portion 324.

In particular, the handle portions 316,318,320,322,324 generally extend relative to each other so as to be bisected by a plane 357 (see FIGS. 9 and 11), relative to which plane 357 the axis 350 is generally orthogonally oriented. Furthermore, handle portion 324 longitudinally extends along its length along axis 352, which axis 252 is generally orthogonal to and intersects axis 350, perhaps as best seen from FIGS. 9 and 10. The shank 304 and adapter 306 also are bisected by a plane 359 (FIG. 11) within which axis 350 and axis 352 extend. It will further be appreciated that plane 357 orthogonally intersects plane 359, as seen in FIG. 11.

The partially exploded, shaded view of FIG. 12 reveals that a proximal end 305 of the shank 304 extends through the adapter 306 and is received within the distal end of the handle 308, and that the adapter 306 frictionally fits within the distal end of the handle 308. In alternatives, the adapter 306 is secured to the distal end of the handle 308 by threaded engagement, by an adhesive, or both. Furthermore, it is contemplated that other means of securing these components could be used. FIG. 12 further perhaps best illustrates a handgrip 309 comprising a no-slip resilient material for gripping of the paint roller frame by hand.

As seen in FIG. 10, the handgrip 309 extends from the proximal end 326 of elongate handle portion 316 (which represents the lowest elevation of the paint roller frame, as seen in FIG. 10), to proximate the first, curved elbow portion 318 that is above the highest elevation of the cage 302. Since the second elongate handle portion 320 extends to the second, curved elbow portion 322 proximate the plane 359, it will be appreciated that the first elongate handle portion 316 is longer than the second elongate handle portion 320. It will further be appreciated that the inner angle a formed by the first curved elbow portion 318 is acute and that the inner angle b formed by the second curved elbow portion 322 is obtuse, as perhaps best seen in FIG. 10.

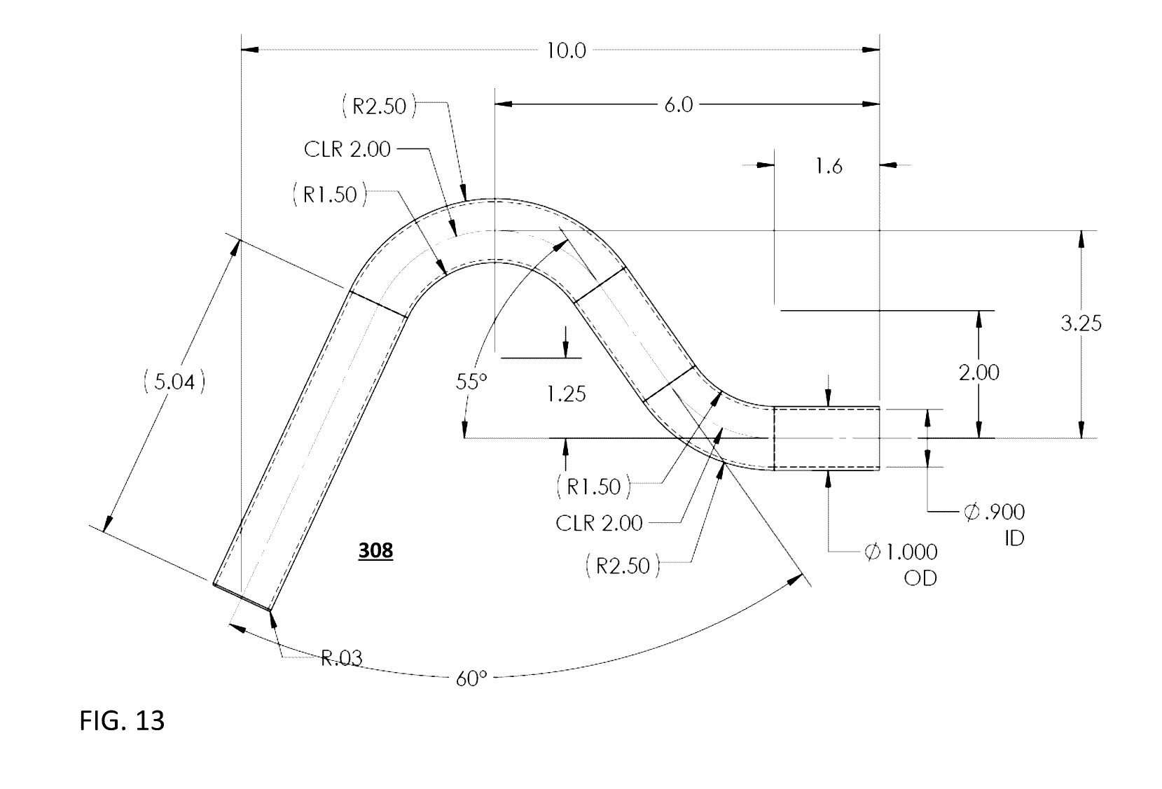

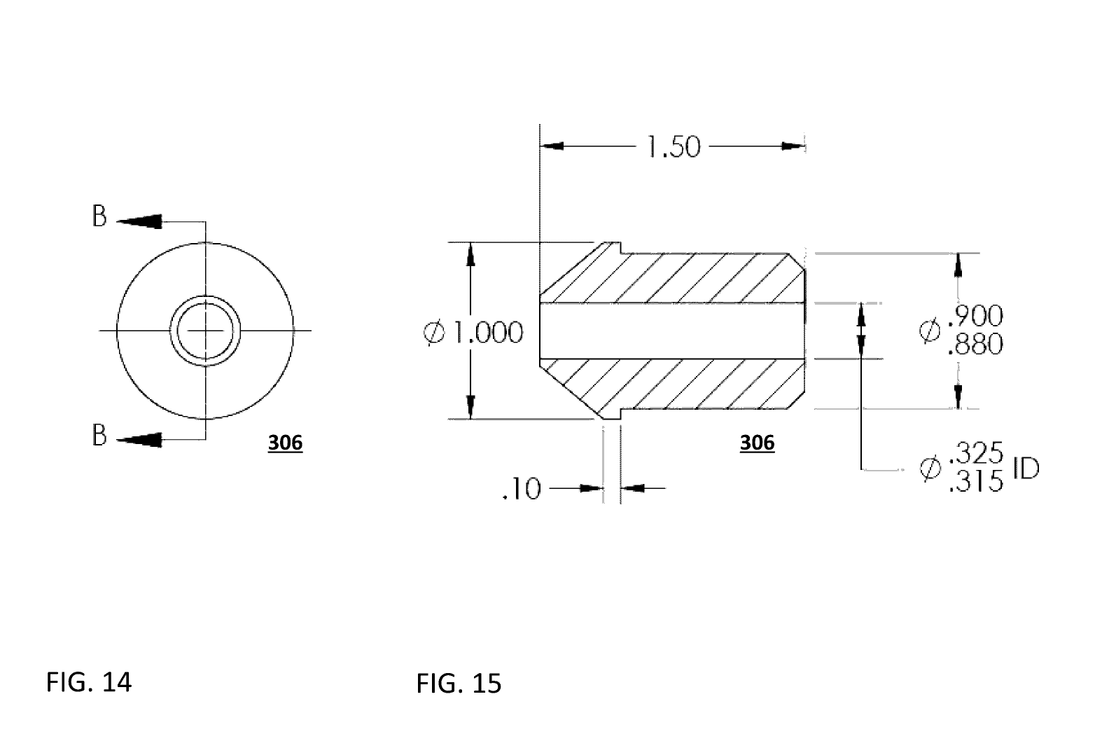

FIG. 13 is a schematic illustration of a side elevational plan view of a handle 308 of the paint roller frame of FIG. 8, wherein the handgrip 309 has been omitted and wherein various preferred dimensions are set forth. Similarly, FIG. 14 is a schematic illustration of a front elevational plan view of the adapter 306 of the roller frame of FIG. 8 by which the handle is attached to the shank 304 of the paint roller frame 310; and FIG. 15 is a schematic illustration of a cross-sectional view of the adapter 306 taken along the line B-B of FIG. 14, wherein various preferred dimensions are set forth. The preferred dimensions disclosed in FIGS. 13, 14 and 15 are in inches. Furthermore, additional schematics and information regarding the materials and dimensions are found in the Appendix, which is incorporated herein by reference.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A paint roller frame, comprising:
(a) a cage configured to receive a roller;
(b) a shank, to which the cage is attached and configured to rotate relative thereto about an axis of rotation; and
(c) a handle to which the shank is attached in fixed position relative thereto, the handle comprising therealong in sequence from a first, proximal end thereof to a second, distal end thereof,
(i) a first, generally elongate handle portion,
(ii) a first, curved elbow handle portion,
(iii) a second, generally elongate handle portion,
(iv) a second, curved elbow handle portion, and
(v) a third, generally elongate handle portion;
(d) wherein the handle portions of the handle generally extend relative to each other so as to be bisected by a handle plane, relative to which handle plane the axis of rotation is generally orthogonally oriented.

2. The paint roller frame of claim 1, wherein the third, generally elongate handle portion longitudinally extends along its length along a third handle portion axis that is generally orthogonal to and intersects the axis of rotation.

3. The paint roller frame of claim 1, further comprising an adapter attached at the distal end of the handle, the adapter attaching the shank to the handle.

4. The paint roller frame of claim 3, wherein the shank and the adapter are bisected by a shank plane within which the axis of rotation and the third handle portion axis extend.

5. The paint roller frame of claim 4, wherein the shank plane orthogonally intersects the handle plane.

6. The paint roller frame of claim 3, wherein a proximal end of the shank extends through the adapter and is received within the distal end of the handle, and wherein the adapter frictionally fits within the distal end of the handle.

7. The paint roller frame of claim 3, wherein the adapter is secured to the distal end of the handle by threaded engagement.

8. The paint roller frame of claim 3, wherein the adapter is secured to the distal end of the handle by an adhesive.

9. The paint roller frame of claim 1, further comprising a handgrip for gripping of the paint roller frame by hand.

10. The paint roller frame of claim 9, wherein handgrip comprises a no-slip resilient material.

11. The paint roller frame of claim 9, wherein handgrip comprises a rubber material.

12. The paint roller frame of claim 9, wherein the handgrip extends from the proximal end of the elongate handle portion representing the lowest elevation of the paint roller frame as seen from the side, to proximate the first, curved elbow handle portion above the highest elevation of the cage as seen from the side.

13. The paint roller frame of claim 1, wherein the shank is bisected by a shank plane within which the axis of rotation and the third handle portion axis extend, and wherein the second elongate handle portion extends to the second, curved elbow portion proximate the shank plane.

14. The paint roller frame of claim 1, wherein the first elongate handle portion is longer than the second elongate handle portion.

15. The paint roller frame of claim 1, wherein an inner angle formed by the first curved elbow handle portion is acute and an inner angle formed by the second curved elbow handle portion is obtuse.

16. The paint roller frame of claim 1, wherein the handle is formed from aluminum tubing.

17. The paint roller frame of claim 1, wherein the shank is formed from aluminum.

18-19. (canceled)

20. A paint roller comprising a paint roller frame comprising:
(a) a cage configured to receive a roller;
(b) a shank, to which the cage is attached and configured to rotate relative thereto about an axis of rotation; and
(c) a handle to which the shank is attached in fixed position relative thereto, the handle comprising therealong in sequence from a first, proximal end thereof to a second, distal end thereof,
(i) a first, generally elongate handle portion,
(ii) a first, curved elbow handle portion,
(iii) a second, generally elongate handle portion,
(iv) a second, curved elbow handle portion, and
(v) a third, generally elongate handle portion;
(d) wherein the handle portions of the handle generally extend relative to each other so as to be bisected by a handle plane, relative to which handle plane the axis of rotation is generally orthogonally oriented.

21-22. (canceled)

23. A paint roller frame, comprising:
(a) a cage configured to receive a roller;
(b) a shank, to which the cage is attached and configured to rotate relative thereto about an axis of rotation; and
(c) a handle to which the shank is attached in fixed position relative thereto, the handle comprising therealong in sequence from a first, proximal end thereof to a second, distal end thereof,
(i) a first, generally elongate handle portion,
(ii) a first, curved elbow handle portion,
(iii) a second, generally elongate handle portion,
(iv) a second, curved elbow handle portion, and
(v) a third, generally elongate handle portion;
(d) wherein the handle portions of the handle generally extend relative to each other so as to be bisected by a handle plane, relative to which handle plane the axis of rotation is generally orthogonally oriented;
(e) wherein the third, generally elongate handle portion longitudinally extends along its length along a third handle portion axis that is generally orthogonal to and intersects the axis of rotation;
(f) wherein the shank is bisected by a shank plane within which the axis of rotation and the third handle portion axis extend, and wherein the second elongate handle portion extends to the second, curved elbow portion proximate the shank plane.

24. The paint roller frame of claim 23, wherein the first elongate handle portion is longer than the second elongate handle portion, and wherein an inner angle formed by the first curved elbow handle portion is acute and an inner angle formed by the second curved elbow handle portion is obtuse.
